(19) United States
(12) Patent Application Publication
(10) Pub. No.: US 2025/0148549 A1
(43) Pub. Date: May 8, 2025

(54) INFORMATION PROCESSING DEVICE AND INFORMATION PROCESSING METHOD

(71) Applicant: TOYOTA JIDOSHA KABUSHIKI KAISHA, Toyota-shi (JP)

(72) Inventors: Kento IWAHORI, Nagoya-shi (JP); Daiki YOKOYAMA, Miyoshi-shi (JP)

(73) Assignee: TOYOTA JIDOSHA KABUSHIKI KAISHA, Toyota-shi (JP)

(21) Appl. No.: 18/828,083

(22) Filed: Sep. 9, 2024

(30) Foreign Application Priority Data
Nov. 6, 2023 (JP) 2023-189342

(51) Int. Cl. G06Q 50/04; B62D 65/18; G05D 1/221

(52) U.S. Cl. CPC G06Q 50/04; G05D 1/221; B62D 65/18

(57) ABSTRACT

The information processing device includes an acquisition unit that acquires attachment information regarding whether or not a communication device used for remote control is attached to a mobile body operable by remote control, a process that outputs an instruction to attach the temporary communication device to the mobile body when it is determined that the permanent communication device is not attached to the mobile body by using the attachment information, and an instruction unit that outputs an instruction to remove the temporary communication device from the mobile body when it is determined that the temporary communication device is attached to the mobile body whose remote control has ended by using the attachment information.

### CROSS-REFERENCE TO RELATED APPLICATION

This application claims priority to Japanese Patent Application No. 2023-189342 filed on Nov. 6, 2023, incorporated herein by reference in its entirety.

### BACKGROUND

### 1. Technical Field

The present disclosure relates to an information processing device and an information processing method.

### 2. Description of Related Art

There is known a technique of causing a vehicle to travel through remote control in a vehicle manufacturing process (e.g. Japanese Unexamined Patent Application Publication (Translation of PCT Application) No. 2017-538619 (JP 2017-538619 A)).

### SUMMARY

In order to remotely control a mobile body that does not include a permanent communication device, a temporary communication device is occasionally attached to the mobile body. When the temporary communication device is used, there is a possibility of forgetting to attach the temporary communication device to the mobile body, and there is a possibility of forgetting to detach the temporary communication device from the mobile body for which remote control has been finished.

The present disclosure can be implemented in the following aspects.
(1) A first aspect of the present disclosure provides an information processing device.
The information processing device includes:
an acquisition unit that acquires attachment information about whether a communication device for use for remote control is attached to a mobile body operable through the remote control; and
an instruction unit that executes at least one of a process of outputting an instruction to attach a temporary communication device to the mobile body when it is determined that a permanent communication device is not attached to the mobile body using the attachment information, and
a process of outputting an instruction to remove the temporary communication device from the mobile body when it is determined that the temporary communication device is attached to the mobile body for which the remote control has been finished using the attachment information.
With the information processing device according to this aspect, it is possible to suppress at least one of forgetting to attach the temporary communication device to the mobile body and forgetting to detach the temporary communication device from the mobile body.
(2) In the information processing device according to the above aspect,
the remote control may be executed in a factory that manufactures the mobile body; and
the acquisition unit may acquire the attachment information from at least one of an external sensor provided in the factory to detect the mobile body and a process management device that manages a manufacturing process for the mobile body in the factory.
With the information processing device according to this aspect, it is possible to easily acquire attachment information.
(3) In the information processing device according to the above aspect,
the mobile body may include an actuator and a control device that controls the actuator; and
the permanent communication device and the temporary communication device may receive information that indicates an instruction value for the control device to control the actuator or information for the control device to determine the instruction value.
With the information processing device according to this aspect, the control device of the mobile body can control the actuator using the information received by the permanent communication device or the temporary communication device.
(4) In the information processing device according to the above aspect,
information received by the permanent communication device when the permanent communication device is attached to the mobile body may be the same as information received by the temporary communication device when the temporary communication device is attached to the mobile body.
With the information processing device according to this aspect, it is possible to suppress complication of the remote control due to a difference between the information received by the permanent communication device when the permanent communication device is attached to the mobile body and the information received by the temporary communication device when the temporary communication device is attached to the mobile body.
(5) A second aspect of the present disclosure provides an information processing method.
The information processing method includes:
acquiring attachment information about whether a communication device for use for remote control is attached to a mobile body operable through the remote control; and
executing at least one of a process of outputting an instruction to attach a temporary communication device to the mobile body when it is determined that a permanent communication device is not attached to the mobile body using the attachment information, and
a process of outputting an instruction to remove the temporary communication device from the mobile body when it is determined that the temporary communication device is attached to the mobile body for which the remote control has been finished using the attachment information.
With the information processing method according to this aspect, it is possible to suppress at least one of forgetting to attach the temporary communication device to the mobile body and forgetting to detach the temporary communication device from the mobile body.
The present disclosure can be implemented in various forms other than the information processing device and the information processing method. For example, the present disclosure can be implemented in the form of a remote control system, a remote control device, a remote control method, a computer program, a storage medium storing a computer program, and the like.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an explanatory diagram illustrating a configuration of an unmanned driving system including an information processing device;

FIG. 2A is an explanatory view showing a configuration of a first vehicle;

FIG. 2B is an explanatory view showing a configuration of a second vehicle;

FIG. 3 is an explanatory view showing a configuration of a vehicle control device;

FIG. 4 is an explanatory view showing a state in which a vehicle moves by remote control in a factory;

FIG. 5 is a flowchart showing a procedure of driving control of a vehicle;

FIG. 6 is a flowchart showing the contents of the attachment instruction processing;

FIG. 7 is a flowchart showing the contents of the removal instruction processing;

FIG. 8A is an explanatory view showing a state in which an attachment instruction and a detachment instruction are transmitted; and

FIG. 8B is an explanatory diagram illustrating a state in which an attachment instruction and a detachment instruction are transmitted.

### DETAILED DESCRIPTION OF EMBODIMENTS

### A. First Embodiment

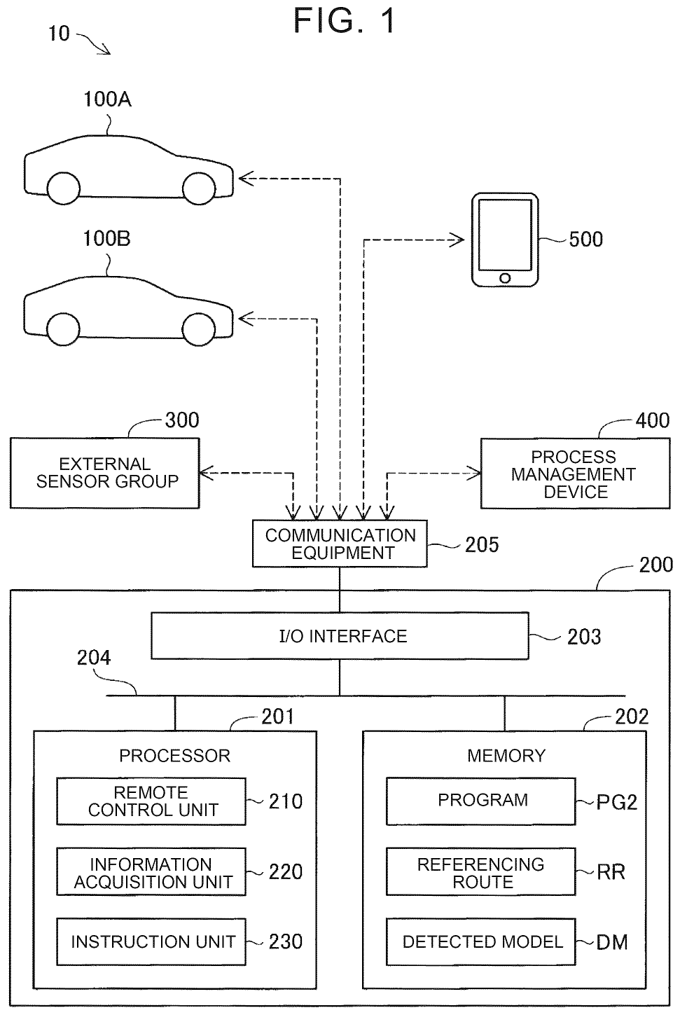

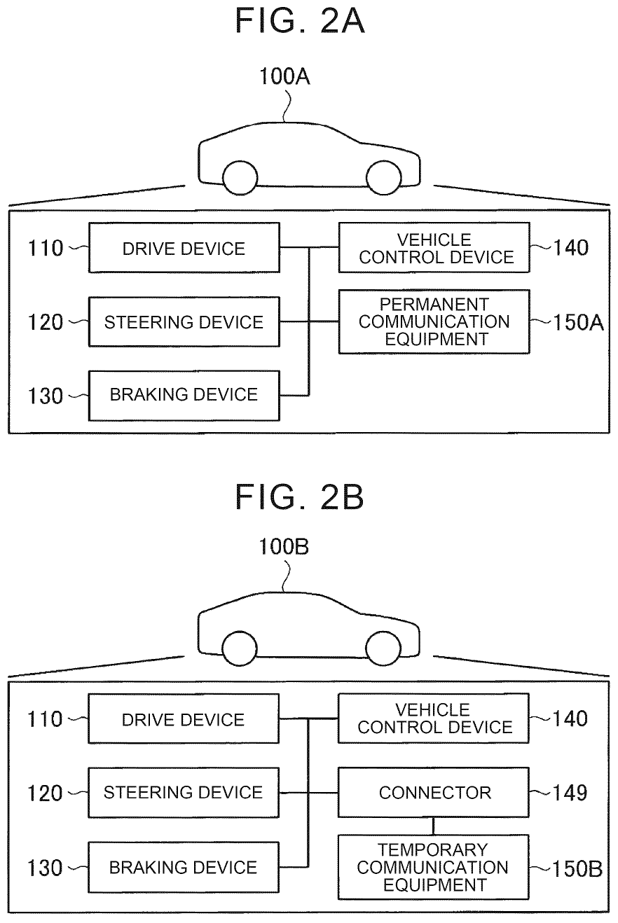

FIG. 1 is an explanatory diagram illustrating a configuration of an unmanned driving system 10 including an information processing device 200 according to a first embodiment. FIG. 2A is an explanatory diagram illustrating a configuration of a vehicle 100A that is a mobile body. FIG. 2B is an explanatory diagram illustrating a configuration of a vehicle 100B. FIG. 3 is an explanatory diagram illustrating a configuration of the vehicle control device 140. The unmanned driving system 10 is used to move a moving object by unmanned driving in a factory that manufactures the moving object.

In the present disclosure, “moving object” means a movable object, and is, for example, a vehicle or an electric vertical takeoff and landing machine (a so-called flying vehicle). The vehicle may be a vehicle traveling by a wheel or a vehicle traveling by an infinite track, and is, for example, a passenger car, a truck, a bus, a two-wheeled vehicle, a four-wheeled vehicle, a tank, a construction vehicle, or the like. Vehicles include battery electric vehicle (BEV), gasoline-powered vehicles, hybrid electric vehicle, and fuel cell electric vehicle. When the moving body is other than the vehicle, the expressions of “vehicle” and “vehicle” in the present disclosure can be appropriately replaced with “moving body”, and the expression of “traveling” can be appropriately replaced with “moving”.

The term “unmanned driving” means driving that does not depend on the traveling operation of the passenger. The traveling operation means an operation related to at least one of “running”, “turning”, and “stopping” of the vehicle. Unmanned driving is realized by automatic or manual remote control using a device located outside the vehicle, or by autonomous control of the vehicle. The vehicle traveling by the unmanned driving may be occupied by a passenger who does not perform the traveling operation. The passenger who does not perform the traveling operation includes, for example, a person who simply sits on the seat of the vehicle, and a person who performs a work different from the traveling operation such as an assembling operation, an inspection operation, and an operation of switches while riding on the vehicle. Driving by the traveling operation of the occupant is sometimes referred to as “manned driving”.

In the present disclosure, “remote control” includes “full remote control” in which all of the operation of the vehicle is completely determined from the outside of the vehicle, and “partial remote control” in which a part of the operation of the vehicle is determined from the outside of the vehicle. Also, “autonomous control” includes “full autonomous control” and “partial autonomous control”. In “fully autonomous control”, a vehicle autonomously controls its operation without receiving any information from a device external to the vehicle. In “partial autonomous control”, the vehicle autonomously controls its operation by using information received from a device outside the vehicle.

As illustrated in FIG. 1, the unmanned driving system 10 includes vehicles 100A, 100B operable by remote control, an information processing device 200 for remotely controlling vehicles 100A, 100B, and an external sensor group 300 installed in a factory. Further, the unmanned driving system 10 includes a process management device 400 for managing a manufacturing process of vehicles 100A, 100B in a factory, and a mobile terminal 500 carried by a worker in the factory. In the following explanation, the vehicle 100A is referred to as a first vehicle 100A, and the vehicle 100B is referred to as a second vehicle 100B. When the first vehicle 100A and the second vehicle 100B are described without being particularly distinguished from each other, they are simply referred to as a vehicle 100. Note that the information processing device 200 may be referred to as a remote control apparatus.

As shown in FIGS. 2A and 2B, the first vehicle 100A and the second vehicle 100B include a drive device 110 for accelerating the host vehicle, a steering device 120 for changing the traveling direction of the host vehicle, a braking device 130 for decelerating the host vehicle, and a vehicle control device 140 for controlling each unit of the host vehicle. The drive device 110 includes an actuator for accelerating the host vehicle, the steering device 120 includes an actuator for changing the traveling direction of the host vehicle, and the braking device 130 includes an actuator for decelerating the host vehicle. In the present embodiment, the drive device 110 includes a battery, a traveling motor driven by electric power of the battery, and driving wheels rotated by the traveling motor. The driving motor is included in an actuator for accelerating the host vehicle.

The first vehicular 100A further includes a permanent communicator 150A for communicating with the information processing device 200 by radio communication. The permanent communication device 150A is a communication device permanently installed in the first vehicle 100A, and is not removed from the first vehicle 100A except for replacement, repair, or the like after being attached to the first vehicle 100A in a factory. Therefore, the first vehicular 100A is sold to the user while the permanent communication device 150A is attached.

The second vehicular 100B does not include a permanent communicator 150A. The second vehicular 100B includes a connector 149 to which a temporary communicator 150B for communicating with the information processing device 200 by radio communication is attached. The temporary communication device 150B is a communication device temporarily installed in the second vehicle 100B, and is detached from the second vehicle 100B after being mounted on the second vehicle 100B in a factory and prior to the second vehicle 100B being sold to the user. In the present embodiment, the temporary communicator 150B is removed from the second vehicle 100B prior to shipping the second vehicle 100B from the factory. Therefore, the second vehicular 100B is sold to the user without the temporary communicator 150B attached.

As illustrated in FIG. 3, the vehicle control device 140 includes a computer including a processor 141, a memory 142, an input/output interface 143, and an internal bus 144. The processor 141, the memory 142, and the input/output interface 143 are bidirectionally communicably connected to each other via an internal bus 144. A drive device 110, a steering device 120, and a braking device 130 are connected to the input/output interface 143. The permanent communication device 150A is connected to the input/output interface 143 of the first vehicle 100A, and the temporary communication device 150B is connected to the input/output interface 143 of the second vehicle 100B via the connector 149. The processor 141 functions as a travel control unit 145 that executes travel control of the vehicles 100 by executing computer program PG1 stored in advance in the memory 142. “Travel control” means, for example, adjustment of acceleration, speed, and steering angle of the vehicle 100. The travel control unit 145 executes travel control, in other words, controls the drive device 110, the steering device 120, and the braking device 130 to cause the host vehicle to travel. When the occupant is on the host vehicle, the travel control unit 145 can cause the host vehicle to travel by controlling the various devices 110, 120, and 130 in accordance with the operation of the occupant. In the present embodiment, the travel control unit 145 can cause the host vehicle to travel by controlling the various devices 110, 120, and 130 in accordance with a control command received from the information processing device 200, regardless of whether or not an occupant is on the host vehicle.

As illustrated in FIG. 1, the information processing device 200 includes a computer including a processor 201, a memory 202, an input/output interface 203, and an internal bus 204. The processor 201, the memory 202, and the input/output interface 203 are bidirectionally communicably connected to each other via an internal bus 204. A communication device 205 for communicating with the respective vehicles 100A, 100B and the mobile terminal 500 by radio communication is connected to the input/output interface 203. In the present embodiment, the communication device 205 can communicate with the external sensor group 300 and the process management device 400 by wired communication or wireless communication.

The processor 201 functions as a remote control unit 210, an information acquisition unit 220, and an instruction unit 230 by executing a computer program PG2 stored in advance in the memory 202. The remote control unit 210 generates a control command for remotely controlling the vehicle 100, and transmits the control command to the vehicle 100 to cause the vehicle 100 to travel. The information acquisition unit 220 acquires mounting information indicating whether or not the vehicles 100 are equipped with the permanent communication device 150A. The instruction unit 230 executes a process of outputting an instruction to attach the temporary communication device 150B to the vehicle 100 using the attachment information, and a process of outputting an instruction to remove the temporary communication device 150B from the vehicle 100 using the attachment information.

The external sensor group 300 includes a plurality of external sensors. The external sensor is a sensor installed outside the vehicle 100. An external sensor is used to detect the position and orientation of the vehicle 100. In the present embodiment, the external sensor group 300 includes a plurality of cameras installed in a factory. Each camera includes a communication device (not shown), and can communicate with the information processing device 200 by wired communication or wireless communication.

The process management device 400 manages the overall manufacturing process of the vehicle 100 in the factory. The process management device 400 includes at least one computer. The process management device 400 includes a communication device (not shown), and can communicate with the information processing device 200 by wired communication or wireless communication. The process management device 400 performs management of the progress of the manufacturing process of each vehicle 100, in other words, management of the stage to which the manufacturing process of each vehicle 100 has advanced. The process management device 400 performs management of when, where, and which worker performs what work.

The mobile terminal 500 includes a display screen for displaying various types of information. The mobile terminal 500 includes a communication device (not shown) and can communicate with the information processing device 200 by wireless communication. The mobile terminal 500 displays the information received from the information processing device 200 on a display screen. In the present embodiment, the mobile terminal 500 is a tablet terminal. The mobile terminal 500 is not limited to a tablet terminal, and may be, for example, a notebook personal computer or a smartphone.

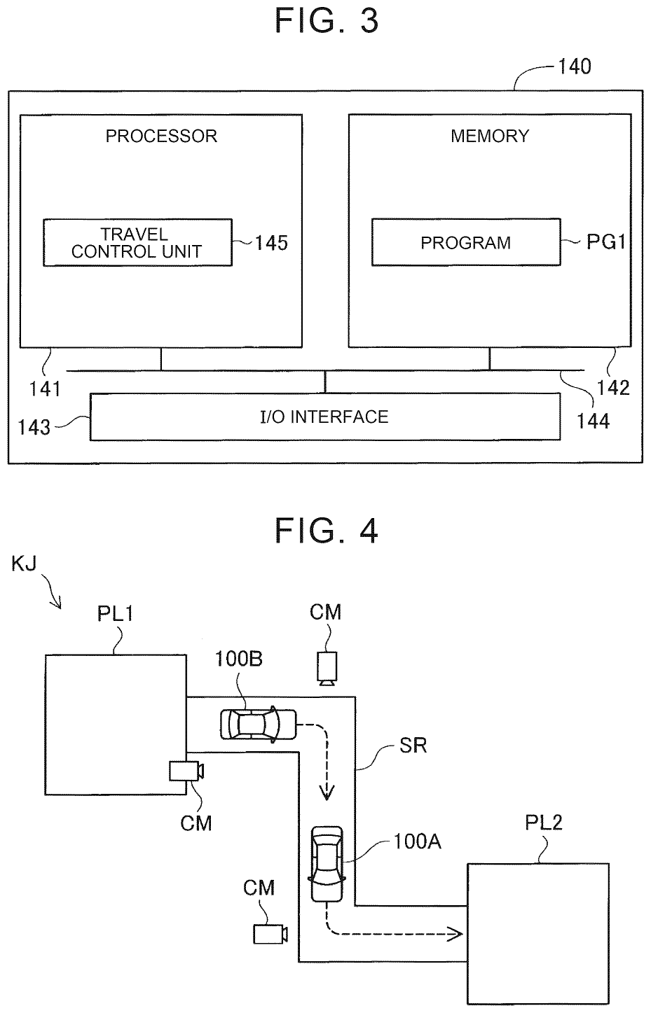

FIG. 4 is an explanatory diagram illustrating a state in which the first vehicle 100A and the second vehicle 100B are moved by remote control in the factory KJ. In the present embodiment, the factory KJ includes a first location PL1 and a second location PL2. The first location PL1 and the second location PL2 are connected by a traveling road SR on which the respective vehicles 100A, 100B can travel. In the present embodiment, the first location PL1 is a location where the respective vehicles 100A, 100B are assembled. The second location is a location where the respective vehicles 100A, 100B are inspected.

The first vehicle 100A is conveyed to a predetermined start point of the first location PL1 while the drive device 110, the steering device 120, the braking device 130, the vehicle control device 140, and the permanent communication device 150A are mounted. The second vehicle 100B is conveyed to the start point while the drive device 110, the steering device 120, the braking device 130, and the vehicle control device 140 are attached thereto. A temporary communicator 150B is mounted on the second vehicular 100B at the start point. The respective vehicles 100A, 100B are remotely controlled by the remote control unit 210 to travel from the start point of the first location PL1 to a predetermined goal point of the second location PL2. At the goal point, the temporary communicator 150B is removed from the second vehicular 100B. The respective vehicles 100A, 100B that passed the test in the second location PL2 are then shipped from the factory KJ.

A method in which the remote control unit 210 moves the vehicle 100 by remote control will be briefly described with reference to FIG. 4. The remote control unit 210 determines a target route for the vehicles 100 to travel to the destination through the traveling road SR. In the present embodiment, the target route is a referencing route RR to be described later. A plurality of camera CM for photographing the traveling road SR are installed in the factory KJ. The plurality of camera CM are included in the external sensor group 300. The remote control unit 210 can acquire the relative position and orientation of the vehicles 100 with respect to the target route in real time by analyzing the images captured by the respective camera CM. The remote control unit 210 generates a control command for causing the vehicle 100 to travel along the target route, and transmits the control command to the vehicle 100. In the present embodiment, the control command is a travel control signal to be described later. The control command indicates a target value of the acceleration of the vehicle 100 and a target value of the steering angle. The vehicle control device 140 mounted on the vehicle 100 drives the vehicle 100 by controlling the drive device 110, the steering device 120, and the braking device 130 using a control command received by the permanent communication device 150A or the temporary communication device 150B. Therefore, the vehicle 100 can be moved without using a conveyance device such as a crane or a conveyor.

In the present embodiment, the remote control unit 210 transmits the same control command to the vehicle 100 between the case where the permanent communication device 150A is mounted in the vehicle 100 and the case where the temporary communication device 150B is mounted in the vehicle 100. That is, when the remote control target is the first vehicle 100A, the remote control unit 210 transmits a control command indicating the target value of the acceleration of the first vehicle 100A and the target value of the steering angle to the first vehicle 100A. Even when the remote control target is the second vehicle 100B, the remote control unit 210 transmits a control command indicating the target value of the acceleration of the second vehicle 100B and the target value of the steering angle to the second vehicle 100B. Therefore, the process executed by the remote control unit 210 to remotely control the vehicle 100 may not be different between the case where the first vehicle 100A is remotely controlled and the case where the second vehicle 100B is remotely controlled. Therefore, it is possible to suppress complication of processing executed by the remote control unit 210 for remote control of the vehicle 100. Note that the target value of the acceleration and the target value of the steering angle of the vehicle 100 may be referred to as a command value.

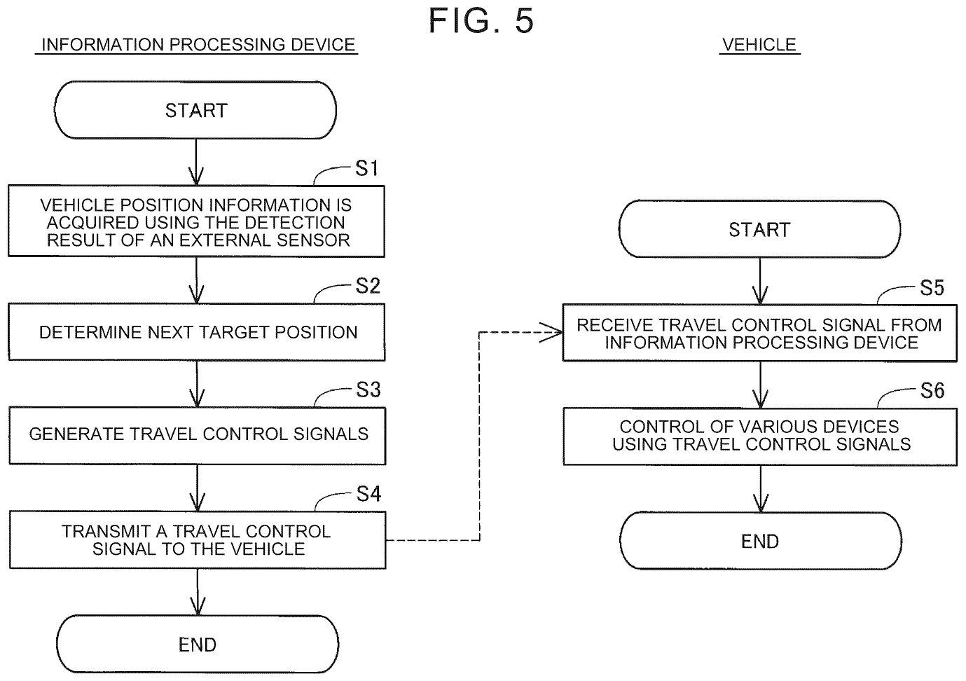

FIG. 5 is a flowchart illustrating a procedure of travel control of the vehicle 100. A method in which the remote control unit 210 causes the vehicle 100 to travel by remote control will be described in more detail with reference to FIG. 5. In S1, the remote control unit 210 acquires the vehicle position data of the vehicle 100 by using a detection result outputted from an external sensor that is a sensor located outside the vehicle 100. The vehicle position information is position information that is a basis for generating a travel control signal. In the present embodiment, the vehicle position information includes the position and orientation of the vehicle 100 in the reference coordinate system of the factory KJ. In the present embodiment, the reference coordinate system of the factory KJ is a global coordinate system, and any position in the factory KJ is represented by the coordinates of X, Y, Z in the global coordinate system. In the present embodiment, the external sensor is a camera CM, and a captured image is outputted from the external sensor as a detected result. That is, in S1, the remote control unit 210 acquires the vehicle position information using the captured image acquired from the camera CM which is an external sensor.

Specifically, in S1, the remote control unit 210 detects the external shape of the vehicle 100 from the captured images, for example. Then, the remote control unit 210 calculates the coordinates of the positioning point of the vehicle 100 in the coordinate system of the captured image, that is, the local coordinate system. Then, the remote control unit 210 acquires the position of the vehicle 100 by converting the calculated coordinates into the coordinates in the global coordinate system. The outline of the vehicle 100 included in the captured image can be detected by, for example, inputting the captured image into a detected model DM using artificial intelligence. The detected model DM is prepared in the unmanned driving system 10 or outside the unmanned driving system 10, for example, and stored in the memory 202 of the information processing device 200 in advance. The detected model DM may be, for example, a learned machine learning model learned to implement either semantic segmentation or instance segmentation. As the machine learning model, for example, a convolutional neural network (hereinafter, CNN) learned by supervised learning using a learning dataset can be used. The training data set includes, for example, a plurality of training images including the vehicle 100 and a label indicating which of the regions in the training image indicates the vehicle 100 and the regions other than the vehicle 100. When CNN is learned, the parameters of CNN are preferably updated by back propagation so as to reduce the error between the output-result and-label due to the detected model DM. Further, the processor 201 estimates, for example, based on the orientation of the movement vector of the vehicle 100 calculated from the positional change of the feature point of the vehicle 100 between the frames of the captured image by using the optical flow method. This allows the processor 201 to obtain the orientation of the vehicle 100.

In S2, the remote control unit 210 determines a target position to which the vehicles 100 are to be directed next. In the present embodiment, the target position is represented by the coordinates of X, Y, Z in the global coordinate system. In the memory 202 of the information processing device 200, referencing route RR that is a route on which the vehicles 100 should travel is stored in advance. The route is represented by a node indicating a starting point, a node indicating a passing point, a node indicating a destination, and a link connecting the respective nodes. The remote control unit 210 uses the vehicle position information and the referencing route RR to determine a target position to which the vehicle 100 is to be directed next. The remote control unit 210 determines the target position on the referencing route RR ahead of the current position of the vehicles 100.

At S3, the remote control unit 210 generates a travel control signal for causing the vehicle 100 to travel toward the determined target position. In the present embodiment, the travel control signal includes the acceleration and the steering angle of the vehicle 100 as parameters. In other embodiments, the travel control signal may include the speed of the vehicle 100 as a parameter in place of or in addition to the acceleration of the vehicle 100, or in addition to the acceleration of the vehicle 100. The remote control unit 210 calculates the traveling speed of the vehicle 100 from the transition of the position of the vehicle 100, and compares the calculated traveling speed with the target speed. As a whole, the remote control unit 210 determines the acceleration so that the vehicle 100 accelerates when the traveling speed is lower than the target speed, and determines the acceleration so that the vehicle 100 decelerates when the traveling speed is higher than the target speed. When the vehicle 100 is located on the referencing route RR, the remote control unit 210 determines the steering angle and the acceleration so that the vehicle 100 does not deviate from the referencing route RR. When the vehicle 100 is not located on the referencing route RR, in other words, when the vehicle 100 deviates from the referencing route RR, the remote control unit 210 determines the steering angle and the acceleration so that the vehicle 100 returns to the referencing route RR.

At S4, the remote control unit 210 transmits the generated travel control signal to the vehicles 100. The remote control unit 210 repeats the acquisition of the position of the vehicle 100, the determination of the target position, the generation of the travel control signal, the transmission of the travel control signal, and the like at predetermined intervals.

In S5, the vehicle control device 140 mounted on the vehicle 100 receives the travel control signal transmitted from the information processing device 200. In S6, the vehicle control device 140 controls the drive device 110, the steering device 120, and the braking device 130 by using the received travel control signal, thereby causing the vehicle 100 to travel at the acceleration and the steering angle represented by the travel control signal. The vehicle control device 140 repeats the reception of the travel control signal and the control of the various devices 110, 120, and 130 at a predetermined cycle.

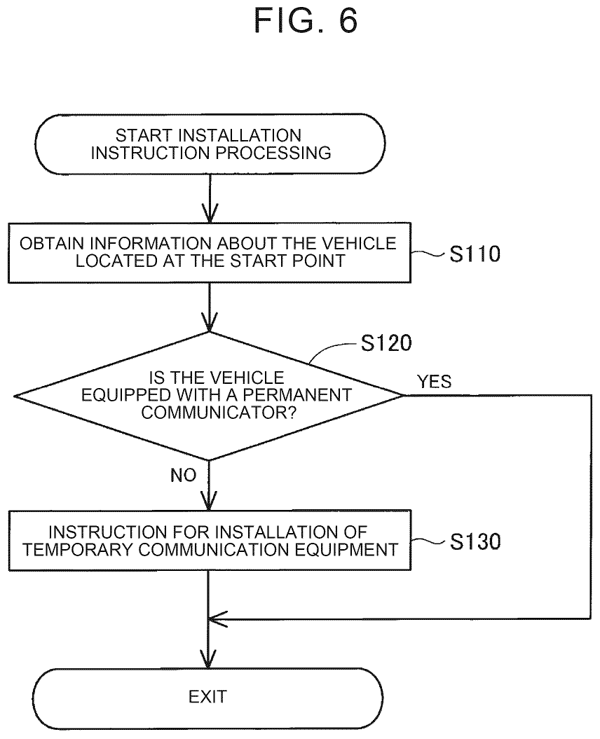

FIG. 6 is a flowchart illustrating the details of the attachment instruction processing. The attachment instruction processing is repeatedly executed by the processor 201 of the information processing device 200. When the attachment instruction process is started, in S110, the information acquisition unit 220 acquires, from the process management device 400, attachment information indicating whether or not the permanent communication device 150A is attached to the vehicles 100 located at the start point of the first location PL1. In the following explanation, the vehicle 100 located at the start point of the first location PL1 is referred to as a target vehicle 100. In the present embodiment, the process management device 400 manages the manufacturing process of each vehicle 100. Therefore, the process management device 400 knows whether or not the vehicle type of the target vehicle 100 is a vehicle type including the permanent communication device 150A. Further, when the vehicle type of the target vehicle 100 is a vehicle type including the permanent communication device 150A, the process management device 400 knows whether or not the process of mounting the permanent communication device 150A on the target vehicle 100 has been completed. That is, the process management device 400 knows whether the permanent communication device 150A is attached to the target vehicle 100.

In S120, the instruction unit 230 determines whether or not the target vehicle 100 includes the permanent communication device 150A by using the attachment information of the target vehicle 100. When it is determined in S120 that the target vehicle 100 includes the permanent communication device 150A, the instruction unit 230 skips the process after S120, and ends the attachment instruction process.

When it is determined in S120 that the target vehicle 100 does not include the permanent communication device 150A, the instruction unit 230 outputs, in S130, a signal for instructing the target vehicle 100 to mount the temporary communication device 150B. In the present embodiment, the worker located at the start point attaches the temporary communication device 150B to the target vehicle 100. The process management device 400 stores a shift table indicating when, where, and which worker is performing work. The instruction unit 230 uses the shift table acquired from the process management device 400 to identify the worker located at the start point. Then, the instruction unit 230 transmits, to the mobile terminal 500 possessed by the worker located at the start point, a signal for instructing to mount the temporary communication device 150B on the target vehicle 100. On the display screen of the received mobile terminal 500, a message instructing to mount the temporary communicator 150B on the target vehicle 100 is displayed. Thereafter, the instruction unit 230 ends the attachment instruction processing. Note that a method including a process executed in the attachment instruction process is sometimes referred to as an information processing method.

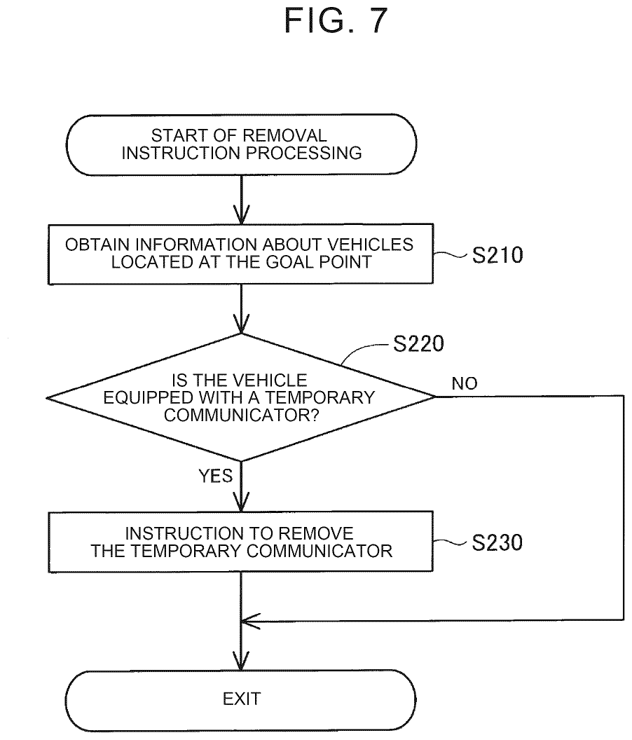

FIG. 7 is a flowchart illustrating the details of the removal instruction processing. The removal instruction processing is repeatedly executed by the processor 201 of the information processing device 200. When the removal instruction process is started, in S210, the information acquisition unit 220 acquires, from the process management device 400, attachment information indicating whether or not the temporary communication device 150B is attached to the vehicles 100 that have been traveled by the remote control located at the goal point. In the following explanation, the vehicle 100 located at the goal point of the second location PL2 is referred to as the target vehicle 100. In the present embodiment, the remote control unit 210 transmits information indicating that the travel by the remote control of the target vehicle 100 has ended to the process management device 400 when the travel by the remote control of the target vehicle 100 has ended. The process management device 400 knows whether or not the vehicle type of the target vehicle 100 is a vehicle type including the permanent communication device 150A, in other words, whether or not remote control of the target vehicle 100 is executed using the temporary communication device 150B.

In S220, the instruction unit 230 determines whether or not the temporary communication device 150B is attached to the target vehicle 100 using the attachment data of the target vehicle 100. The instruction unit 230 skips the process after S220 and ends the removal instruction process when it is determined in S220 that the temporary communication device 150B is not mounted on the target vehicle 100.

When it is determined that the temporary communicator 150B is attached to the target vehicle 100 in S220, the instruction unit 230 outputs a signal for instructing to remove the temporary communicator 150B from the target vehicle 100 in S230. The instruction unit 230 uses the shift table acquired from the process management device 400 to identify the worker located at the goal point. Then, the instruction unit 230 transmits, to the mobile terminal 500 possessed by the worker located at the goal point, an instruction to remove the temporary communication device 150B from the target vehicle 100. On the display screen of the received mobile terminal 500, a message instructing to remove the temporary communicator 150B from the target vehicle 100 is displayed. Thereafter, the instruction unit 230 ends the removal instruction processing. Note that a method including a process executed in the removal instruction process is sometimes referred to as an information processing method.

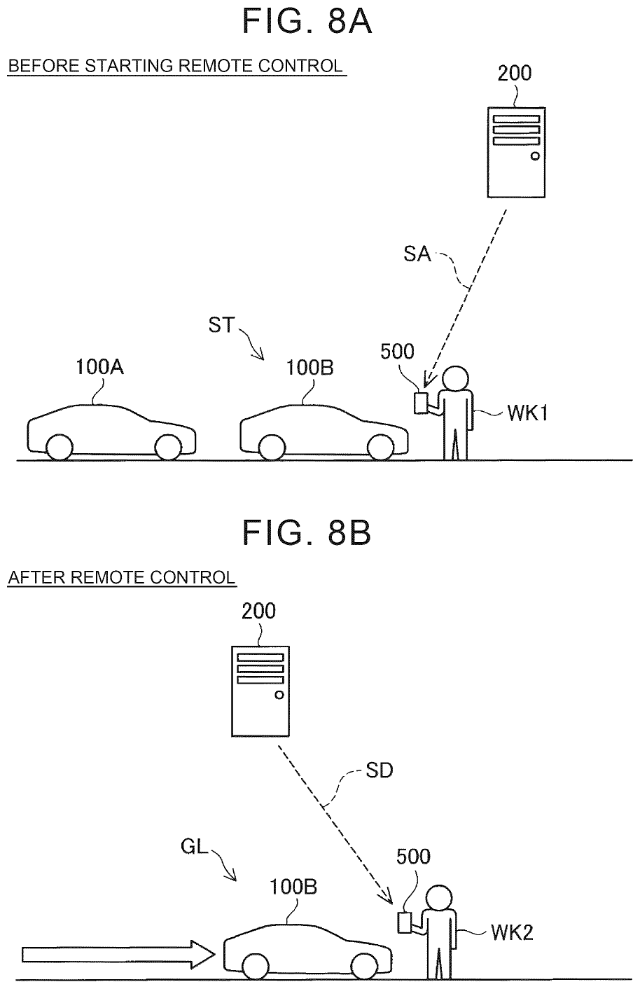

FIGS. 8A and 8B are explanatory diagrams illustrating a state in which the temporary communication device 150B is attached to and detached from the second vehicle 100B. As shown in FIG. 8A, when the permanent communication device 150A is not mounted on the target vehicle 100 located at the start point, in other words, the target vehicle 100 may be the second vehicle 100B. In this instance, an instruction SA is transmitted from the information processing device 200 to the mobile terminal 500 possessed by the worker WK1 located at the start point ST so as to attach the temporary communication device 150B to the target vehicle 100. On the other hand, when the permanent communication device 150A is mounted on the target vehicle 100, in other words, when the target vehicle 100 is the first vehicle 100A, the instruction SA is not transmitted from the information processing device 200 to the mobile terminal 500 possessed by the worker WK1.

As shown in FIG. 8B, when the temporary communicator 150B is mounted on the target vehicle 100 located at the goal point GL, in other words, the target vehicle 100 may be in the second vehicle 100B. In this instance, an instruction SD is transmitted from the information processing device 200 to the mobile terminal 500 possessed by the worker WK2 located at the goal point GL so as to remove the temporary communication device 150B from the target vehicle 100. On the other hand, when the temporary communication device 150B is not mounted on the target vehicle 100, in other words, when the target vehicle 100 is in the first vehicle 100A, the instruction SD is not transmitted from the information processing device 200 to the mobile terminal 500 possessed by the worker WK2.

According to the information processing device 200 of the present embodiment described above, the attachment instruction processing and the detachment instruction processing are executed. Therefore, it is possible to prevent the temporary communicator 150B from being forgotten to be attached to the vehicle 100 without the permanent communicator 150A and the temporary communicator 150B from being forgotten to be detached from the vehicle 100 to which the temporary communicator 150B is attached.

Further, in the present embodiment, since the information processing device 200 acquires the attachment information from the process management device 400, it is possible to easily acquire the attachment information.

Further, in the present embodiment, the vehicle control device 140 can control the actuators of the various devices 110, 120, and 130 by using the information received by the permanent communication device 150A or the temporary communication device 150B.

Further, in the present embodiment, the travel control signal transmitted by the remote control unit 210 to the vehicle 100 is the same between the case where the permanent communication device 150A is mounted on the vehicle 100 and the case where the temporary communication device 150B is mounted on the vehicle 100. Therefore, the travel control signal transmitted by the remote control unit 210 to the vehicle 100 differs between the case where the permanent communication device 150A is attached to the vehicle 100 and the case where the temporary communication device 150B is attached to the vehicle 100. As a result, it is possible to suppress complication of remote control of the vehicle 100.

### B. Other Embodiments

### B1

In the information processing device 200 according to the first embodiment described above, the instruction unit 230 executes the attachment instruction processing and the detachment instruction processing. The instruction unit 230 may not execute any one of the attachment instruction processing and the detachment instruction processing. Even if the instruction unit 230 does not execute the attachment instruction process, it is possible to prevent the temporary communicator 150B from being forgotten to be removed from the vehicles 100 to which the temporary communicator 150B is attached. Even if the instruction unit 230 does not execute the removal instruction process, it is possible to suppress the forgetting to attach the temporary communicator 150B to the vehicles 100 that do not include the permanent communicator 150A.

### B2

In the information processing device 200 according to the first embodiment described above, the instruction unit 230 transmits an instruction to attach the temporary communication device 150B and an instruction to remove the temporary communication device 150B to the mobile terminal 500 possessed by the worker. On the other hand, when the attaching/detaching operation of the temporary communication device 150 is performed by the robot arm instead of the worker, the instruction unit 230 may transmit an instruction for causing the robot controller controlling the robot arm to perform the attaching/detaching of the temporary communication device 150B.

### B3

In the information processing device 200 according to the first embodiment described above, the information acquisition unit 220 acquires, from the process management device 400, attachment information indicating whether or not the permanent communication device 150A is attached to the vehicles 100 located at the start point. On the other hand, a camera or a LiDAR for checking whether or not the permanent communication device 150A is attached to the vehicle 100 may be installed at the start point. The information acquisition unit 220 may acquire the attachment information indicating whether or not the permanent communication device 150A is attached to the vehicle 100 located at the start point by analyzing the image of the camera or the point cloud data of LiDAR. In addition, the permanent communication device 150A may not be attached to the vehicles 100 to which the permanent communication device 150A is to be attached. In this case, the mobile terminal 500 possessed by the worker located at the start point may be sent a signal for instructing the vehicle 100 to mount the permanent communication device 150A. In this case, it is possible to prevent the permanent communication device 150A from being forgotten to be attached.

### B4

In the information processing device 200 according to the first embodiment described above, the information acquisition unit 220 acquires, from the process management device 400, attachment information indicating whether or not the temporary communication device 150B is attached to the vehicles 100 located at the goal point. On the other hand, a camera or a LiDAR for confirming whether or not the temporary communication device 150B is attached to the vehicle 100 may be installed at the goal point. The information acquisition unit 220 may acquire attachment information indicating whether or not the temporary communication device 150B is attached to the vehicle 100 located at the goal point by analyzing the image of the camera or the point cloud data of LiDAR.

### B5

In the above-described first embodiment, the external sensor is a camera CM. On the other hand, the external sensor may not be a camera CM, and may be, for example, a LiDAR (Light Detection And Ranging). In this case, the detection result output from the external sensor may be three-dimensional point cloud data representing the vehicle 100. In this case, the remote control unit 210 may acquire the vehicle position information by template matching using the three-dimensional point cloud data as the detection result and the reference point cloud data prepared in advance.

### B6

In the above-described first embodiment, the information processing device 200 executes processing from acquisition of vehicle position information to generation of a travel control signal. On the other hand, at least a part of the processing from the acquisition of the vehicle position information to the generation of the travel control signal may be executed by the vehicle 100. For example, the following aspects (1) to (3) may be used.

(1) The information processing device 200 may acquire the vehicle position information, determine a target position to which the vehicle 100 should be directed next, and generate a route from the current position of the vehicle 100 represented by the acquired vehicle position information to the target position. The information processing device 200 may generate a route to a target position between the current location and the destination, or may generate a route to the destination. The information processing device 200 may transmit the generated route to the vehicle 100. The vehicle 100 may generate a travel control signal so that the vehicle 100 travels on the route received from the information processing device 200, and control the drive device 110, the steering device 120, and the braking device 130 using the generated travel control signal.

(2) The information processing device 200 may acquire the vehicle position information and transmit the acquired vehicle position information to the vehicle 100. The vehicle 100 may determine a target position to which the vehicle 100 should be heading next, and generate a route from the current position of the vehicle 100 to the target position represented by the received vehicle position information. Then, the vehicle 100 may generate a travel control signal so that the vehicle 100 travels on the generated route, and control the drive device 110, the steering device 120, and the braking device 130 using the generated travel control signal.

(3) In the above aspects (1) and (2), an internal sensor may be mounted on the vehicle 100, and a detection result output from the internal sensor may be used for at least one of generation of a route and generation of a travel control signal. The internal sensor is a sensor mounted on the vehicle 100. The internal sensor may include, for example, a sensor that detects a motion state of the vehicle 100, a sensor that detects an operation state of each unit of the vehicle 100, and a sensor that detects an environment around the vehicle 100. Specifically, the inner sensor may include, for example, a camera, a LiDAR, a millimeter-wave radar, an ultrasonic sensor, a GPS sensor, an accelerometer, a gyroscope, and the like. For example, in the aspect (1), the information processing device 200 may acquire the detection result of the internal sensor and reflect the detection result of the internal sensor in the path when generating the path. In the aspect (1), the vehicle 100 may acquire the detection result of the internal sensor and reflect the detection result of the internal sensor in the travel control signal when generating the travel control signal. In the aspect (2), the vehicle 100 may acquire the detection result of the internal sensor and reflect the detection result of the internal sensor in the path when generating the path. In the aspect (2), the vehicle 100 may acquire the detection result of the internal sensor and reflect the detection result of the internal sensor in the travel control signal when generating the travel control signal.

### B7

In the first embodiment described above, the information processing device 200 automatically generates a travel control signal to be transmitted to the vehicle 100. On the other hand, the information processing device 200 may generate a travel control signal to be transmitted to the vehicle 100 in accordance with an operation of an external operator located outside the vehicle 100. For example, an external operator may operate a control device including a display for displaying a captured image outputted from a camera CM which is an external sensor, a steering for remotely controlling the vehicle 100, an accelerator pedal, a brake pedal, and a communication device for communicating with the information processing device 200 through wired communication or wireless communication. The information processing device 200 may generate a travel control signal corresponding to an operation applied to the control apparatus.

### B8

In the above-described first embodiment, the vehicle 100 may be provided with a configuration that can be moved by unmanned driving, and may be, for example, in the form of a platform having a configuration described below. Specifically, the vehicle 100 may include at least the drive device 110, the steering device 120, the braking device 130, and the vehicle control device 140 in order to perform three functions of “running”, “turning”, and “stopping” by unmanned driving. When the vehicle 100 acquires information from the outside for unmanned driving, the vehicle 100 may further include a permanent communication device 150A or a temporary communication device 150B. That is, the vehicle 100 that can be moved by the unmanned driving may not be equipped with at least a part of an interior component such as a driver's seat or a dashboard. Further, at least a part of an exterior component such as a bumper or a fender may not be attached. The body shell may not be mounted. In this instance, the remaining components, such as the body shell, may be mounted to the vehicle 100 until the vehicle 100 is shipped from the factory KJ. The remaining components, such as the body shell, may be mounted to the vehicle 100 after the vehicle 100 is shipped from the factory KJ with the remaining components, such as the body shell, not being mounted to the vehicle 100. Each of the components may be mounted from any direction, such as the upper side, lower side, front side, rear side, right side or left side of the vehicle 100, each may be mounted from the same direction, or may be mounted from a different direction. It should be noted that the position determination can also be performed for the form of the platform in the same manner as the vehicle 100 according to the first embodiment.

### B9

The vehicle 100 may be manufactured by combining a plurality of modules. The module means a unit composed of a plurality of components arranged in accordance with a part or a function of the vehicle 100. For example, the platform of the vehicle 100 may be manufactured by combining a front module that constitutes a front portion of the platform, a central module that constitutes a central portion of the platform, and a rear module that constitutes a rear portion of the platform. The number of modules constituting the platform is not limited to three, and may be two or less or four or more. In addition to or instead of the components constituting the platform, the components constituting a part of the vehicle 100 different from the platform may be modularized. Further, the various modules may include any exterior parts such as bumpers and grilles, and any interior parts such as sheets and consoles. In addition, not only the vehicle 100 but also a moving object of an arbitrary mode may be manufactured by combining a plurality of modules. Such a module may be manufactured, for example, by joining a plurality of parts by welding, a fixture, or the like, or may be manufactured by integrally molding at least a part of the parts constituting the module as one part by casting. Molding techniques for integrally molding one part, in particular a relatively large part, are also called gigacasting or megacasting. For example, the front module, the central module, and the rear module described above may be manufactured using gigacasting.

### B10

Transporting the vehicle 100 by using the traveling of the vehicle 100 by the unmanned driving is also referred to as “self-propelled conveyance”. A configuration for realizing self-propelled conveyance is also referred to as a “vehicle remote control autonomous traveling conveyance system”. Further, a production method of producing the vehicle 100 by using self-propelled conveyance is also referred to as “self-propelled production”. In self-propelled manufacturing, for example, at least a part of conveyance of the vehicle 100 is realized by self-propelled conveyance in a factory KJ that manufactures the vehicle 100.

### B11

In the first embodiment described above, some or all of the functions and processes implemented in software may be implemented in hardware. In addition, some or all of the functions and processes implemented in hardware may be implemented in software. For example, various circuits such as an integrated circuit and a discrete circuit may be used as hardware for realizing various functions in the above-described embodiments.

The present disclosure is not limited to each of the above embodiments, and can be realized by various configurations without departing from the spirit thereof. For example, the technical features in the embodiments corresponding to the technical features in the respective aspects described in the Summary can be appropriately replaced or combined in order to solve some or all of the above-described problems or to achieve some or all of the above-described effects. Further, when the technical features are not described as essential in the present specification, these can be deleted as appropriate.

What is claimed is:

1. An information processing device comprising:
an acquisition unit that acquires attachment information about whether a communication device for use for remote control is attached to a mobile body operable through the remote control; and
an instruction unit that executes at least one of
a process of outputting an instruction to attach a temporary communication device to the mobile body when it is determined that a permanent communication device is not attached to the mobile body using the attachment information, and
a process of outputting an instruction to remove the temporary communication device from the mobile body when it is determined that the temporary communication device is attached to the mobile body for which the remote control has been finished using the attachment information.

2. The information processing device according to claim 1, wherein:
the remote control is executed in a factory that manufactures the mobile body; and
the acquisition unit acquires the attachment information from at least one of an external sensor provided in the factory to detect the mobile body and a process management device that manages a manufacturing process for the mobile body in the factory.

3. The information processing device according to claim 1, wherein:
the mobile body includes an actuator and a control device that controls the actuator; and
the permanent communication device and the temporary communication device receive information that indicates an instruction value for the control device to control the actuator or information for the control device to determine the instruction value.

4. The information processing device according to claim 1, wherein information received by the permanent communication device when the permanent communication device is attached to the mobile body is the same as information received by the temporary communication device when the temporary communication device is attached to the mobile body.

5. An information processing method comprising:
acquiring attachment information about whether a communication device for use for remote control is attached to a mobile body operable through the remote control; and
executing at least one of
a process of outputting an instruction to attach a temporary communication device to the mobile body when it is determined that a permanent communication device is not attached to the mobile body using the attachment information, and
a process of outputting an instruction to remove the temporary communication device from the mobile body when it is determined that the temporary communication device is attached to the mobile body for which the remote control has been finished using the attachment information.
